(19) United States
(12) Patent Application Publication
(10) Pub. No.: US 2021/0216404 A1
(43) Pub. Date: Jul. 15, 2021

(54) VIRTUAL MEMORY MANAGEMENT

(71) Applicant: TINY LABS, INC., Vista, CA (US)

(72) Inventor: Elliot Benjamin BULLER, Denver, CO (US)

(21) Appl. No.: 16/744,101

(22) Filed: Jan. 15, 2020

(51) Int. Cl. G06F 11/14; G06F 9/32

(52) U.S. Cl. CPC G06F 11/141; G06F 2201/805; G06F 9/32

(57) ABSTRACT

Techniques are described for providing virtual memory management in a computing system as an alternative to a physical memory management unit. A software compiler configures one or more instruction(s) of a compiled software program to reference a trappable memory location in connection with data accesses. During execution of the software program, an operating system with virtual memory management capabilities handles a fault triggered as a result of an attempt, by an instruction of the software program, to access the trappable memory location. As part of handling the fault, the operating system determines an address of a physical memory location to use in place of the trappable memory location and patches a register to point to the physical memory location. The operating system returns from the fault and allows the computing system to re-execute the instruction.

### TECHNICAL FIELD

This disclosure generally relates to techniques for managing physical memory in a computing system without requiring a physical memory management unit (MMU). Specifically, the present disclosure provides a low cost alternative to MMUs that allows an operating system to manage physical memory.

### BACKGROUND

A Memory Management Unit (MMU) is an important piece of hardware for a modern operating system (e.g: Linux, OSX, Windows) or an embedded system. A memory management unit manages physical memory (e.g., Random Access Memory (RAM)) of a computing system by translating virtual memory addresses into physical memory addresses in accordance with the needs of a software program executing on one or more processors of the computing system. Without an MMU, embedded systems are compiled as monolithic images with all memory information known at compile time, which prevents the operating system from dynamically adding/replacing execution of one or more software component(s) at run-time. This high level of integration also puts a natural boundary for testing at the system level, making it difficult to test individual software components of the system.

Embedded development on a microcontroller is a very time intensive process. Developing and maintaining computing devices with microcontrollers in the coming years is going to be increasingly challenging and difficult as the number of connected devices grows exponentially. In contrast to the homogeneous computing environments of servers and personal computers, each embedded computing device may have specialized sensors or interface elements and/or other components unique to the embedded computing device. The difficulty of integrating all of the unique components while considering the application specific requirements demands time consuming development for every embedded computing device. To get a basic hardware platform running for a software developer to develop code on, there are many other tedious porting and integration challenges in addition to domain specific development on embedded computing devices.

While there are tools and development paradigms available to accomplish the hardware and software integration, they have yet to be applied to the development of embedded computing devices. A solution for maintaining high quality software on a large number of heterogeneous computing platforms should enable extensive code reuse and individual unit-testing of each software component. Distribution of binary code for software components on an embedded platform eases development and forces adherence to a strict interface implementation. An MMU supports this solution by enabling a large amount of functional reuse of the underlying hardware in heterogeneous embedded systems. To enable binary code reuse across systems, software components should have the ability to execute from any Read-Only Memory (ROM) address and use RAM or other physical memory available as determined at runtime. Modern compilers such as GCC (GNU Compiler Collection) provide compiler flags to enable position independent execution of software components from anywhere in the ROM address space. On modern processors with an MMU, when compiled software components need to access RAM during execution of the software components, they directly attempt to access the virtual memory addresses allocated to them during compilation. The MMU (configured by the operating system) translates this virtual memory address to a physical memory address based on the current state of the system and allocated memory.

Typically, MMUs are not available in low-end processors because adding an MMU is not only a time consuming, complex and expensive process, but also requires additional physical space on the hardware. Accordingly, there is a need for a framework that easily integrates software and hardware on a computing device without relying on availability of an MMU.

### SUMMARY

The present disclosure describes techniques for providing virtual memory management in a computing system as an alternative to a physical memory management unit. Various embodiments are described herein, including methods, systems, non-transitory computer-readable storage media storing programs, code, or instructions executable by one or more processors, and the like.

In certain embodiments, during an execution of a software program, a virtual memory management subsystem (VMMS) within an operating system responds to a fault as a result of an attempt by an instruction to access a trappable memory location. In certain embodiments, a software compiler configures the instruction to reference the trappable memory location during compilation of the software program. The virtual memory management subsystem may include an installed handler to handle one or more faults triggered by the instruction trying to access a trappable memory location, and an Interrupt Service Routine (ISR) vector table may be configured to trap all memory accesses to a trappable address space.

In certain embodiments, the virtual memory management subsystem handles a fault by determining an address of a physical memory location to use in place of the trappable memory location and patching a register pointing to the trappable memory location to instead point to the physical memory location. To determine the address of the physical memory location, the virtual memory management subsystem identifies an execution address of the instruction responsible for triggering the fault, identifies a fault address corresponding to the trappable memory location that the instruction attempted to access, and calculates an address of the physical memory location using the execution address and the fault address.

In certain embodiments, to identify a fault address, the virtual memory management subsystem obtains the fault address from a hardware accessible fault register. In certain embodiments, virtual memory management subsystem further determines a physical base address assigned to a compilation unit by querying one or more data structures within the computing system to determine a RAM location associated with the compilation unit. The compilation unit can be a set of compiled instructions including an instruction responsible for triggering the fault.

In certain embodiments, as a condition for handling a fault, the virtual memory management subsystem verifies that an instruction responsible for triggering the fault is stored as part of a compilation unit and that the trappable memory location is within a physical memory range allocated to the compilation unit.

In certain embodiments, an instruction attempts to access a trappable memory location as a result of being configured by a software compiler to indirectly access RAM data through referencing a register. The virtual memory management subsystem patches the register, which initially points to the trappable memory location, by replacing the address of the trappable memory location stored in the register with the address of the physical memory location. In certain embodiments, the register is a Position Independent Code (PIC) base register. The virtual memory management subsystem may return from the fault once the fault is handled to allow the instruction to be re-executed.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a conventional computing system with a physical Memory Management Unit (MMU).

FIG. 2 depicts an example of a computing system with a virtual memory management subsystem, in accordance with certain embodiments.

FIG. 3 depicts an example memory structure of a compilation unit, in accordance with certain embodiments.

FIG. 4 depicts an example of a runtime system view of physical memory of a computing system with a virtual memory management subsystem, in accordance with certain embodiments.

FIG. 5 depicts an example memory structure of a computing system with process calls, in accordance with certain embodiments.

FIG. 6 depicts an example of steps performed during compilation of a software program on a computing system with a virtual memory management unit, in accordance with certain embodiments.

FIG. 7 depicts an example of steps performed during execution of a software program by a computing system with a virtual memory management unit in accordance with certain embodiments.

### DETAILED DESCRIPTION

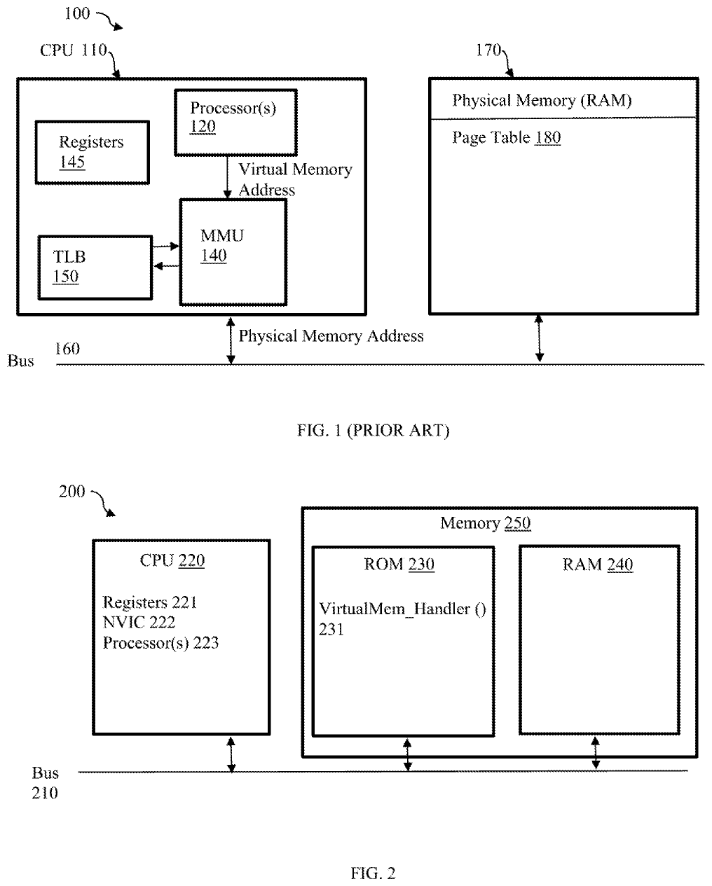

FIG. 1 depicts an example computing system 100 including one or more processor(s) 120 within a Central Processing Unit (CPU) 110, registers 145, and a memory management unit (MMU) 140. MMU 140 is a hardware component that manages allocation of physical memory (e.g., RAM) 170 by translating virtual addresses into physical addresses for accessing physical memory 170 in accordance with the needs of a program executing on the processor(s) 120. While booting and/or loading executable files, the processor(s) 120 set up a page table 180 for a given process context in order to map virtual memory to physical memory. Typically, the processor(s) 120 provide the MMU 140 with a virtual memory address when requesting data from the physical memory 170. The MMU 140 and a translation lookaside buffer (TLB) 150 are responsible for translating the virtual memory address into a physical memory address corresponding to the physical memory 170.

More specifically, attempted accesses to data in memory by programs executing on CPU 110 are sent to MMU 140 and TLB 150. To translate the virtual memory address into the physical memory address, the MMU 140 consults the TLB 150. TLB 150 contains one or more page address tables that divide physical memory 170 into pages. Typically, TLB 150 is part of CPU 110 or MMU 140. TLB 150 typically holds a single entry per cache index (e.g. a portion of the virtual address), where each entry may include a physical page number, permissions for access, etc.

Typically, the MMU 140 is part of CPU 110 (as shown in FIG. 1) or a separate chip external to the CPU 110. Without MMU 140, the CPU 110 directly accesses the physical memory 170 at an address requested by an instruction being executed by the CPU 110. With the inclusion of MMU 140, memory addresses are processed through a translation step prior to each memory access. As such, if an access to a same memory address is requested by different processes, the translation step directs each request to a different physical location. Physical memory 170 can be viewed as an array of fixed-size slots called page frames, each of which corresponds to a single virtual memory address.

On a standard computing system or embedded system 100, all memory parameters are specified at compile time via a linker script which is passed to a linker of a compilation program suite such as GNU Compiler Collection (GCC) as an input for compiling one or more software applications on a target computing system (e.g., computing system 100). For instance, the linker script may specify to the linker that 256 kB of Read/Execute memory (e.g., flash memory) is available at address 0 and 64 kB of Read/Write/Execute memory is available in physical memory (e.g., RAM) at address 0x20000000 using the following script:

MEMORY
{

FLASH (rx) : ORIGIN = 0x00000000, LENGTH = 256k
RAM (rwx) : ORIGIN = 0x20000000, LENGTH = 64k

}

Although linking and compilation are usually performed by separate programs within the compilation program suite, the entire compilation program suite is typically referred to as a compiler. In the example above, without MMU 140, one or more software programs are compiled as a single monolithic image in the computing system 100, and the compiler allocates all variables to unique locations within the available address space in RAM 170. In the above example, a variable from the software program will be located at a statically compiled address within a memory region that begins with address 0x20000000. During run-time, the compiled code simply accesses the statically complied address to read and write from the variable. Each of these accesses generates a bus transaction, using a bus 160 connecting the processor(s) 120 and the RAM 170.

FIG. 2 depicts a computing system 200 that includes a CPU 220 and memory 250. The CPU 220 includes registers 221, a Nested Vectored Interrupt Controller (NVIC) 222, and processor(s) 223. The memory 250 includes Read-Only Memory (ROM) 230, an operating system with a virtual memory management subsystem (VirtualMem_Handler 231), and RAM 240.

In an example embodiment, while loading an executable (e.g., a compilation unit) of one or more software programs, the operating system may update a data structure that maps virtual memory addresses to physical memory addresses for executing the loaded executable. During the execution of the executable, the CPU 220 may request an access (e.g., read or write) to virtual memory that is mapped into a location in a trappable memory region. The access request is communicated over a bus 210 that couples the CPU 220 to the memory 250. The trappable memory region may, for example, be an empty space in a memory map, where the empty space is known to be unused by, or invalid for, any programs executing on the computing system 200.

The request to access the location in the trappable memory region may result in a fault. The fault can be a fault associated with bus 210, which in certain embodiments, provides address/data/command communication between various components in the computing system 200 such as CPU 220, ROM 230 and RAM 240. In certain embodiments, NVIC 222 may trap the invalid access and trigger execution of the VirtualMem_Handler 231. In an example embodiment, the VirtualMem_Handler 231 may resolve the fault by mapping the location in the trappable memory region to a valid physical memory location in RAM 240, using the data structure updated by the operating system. To resolve the fault, the operating system may identify one or more register(s) 221 associated with the request to access the location in the trappable memory region as faulting registers. The register(s) 221 can be hardware registers within CPU 220. The register(s) 221 may hold the instruction, a storage address, or any kind of data pointing to a trappable memory location.

In the above embodiment, a register 221 associated with the request to access the location in the trappable memory region is patched with a physical memory address associated with the physical memory (RAM) 240. For example, the VirtualMem_Handler 231 may patch the faulting register 221 by replacing the invalid virtual memory address, as stored within the faulting register, with the address of a valid physical memory location.

In certain embodiments, the VirtualMem_Handler 231 returns from a fault associated with a request to access a trappable memory location once the faulting register 221 has been patched. Upon return from the fault, the CPU 220 re-executes the instruction associated with the request to access the trappable memory location. In an example embodiment, the VirtualMem_Handler 231 may be part of a kernel within the operating system. In certain embodiments, the process of patching based on a valid physical memory location can be applied to not just the software program(s) (applications, drivers, dynamic libraries, etc.), but to the execution of the operating system itself.

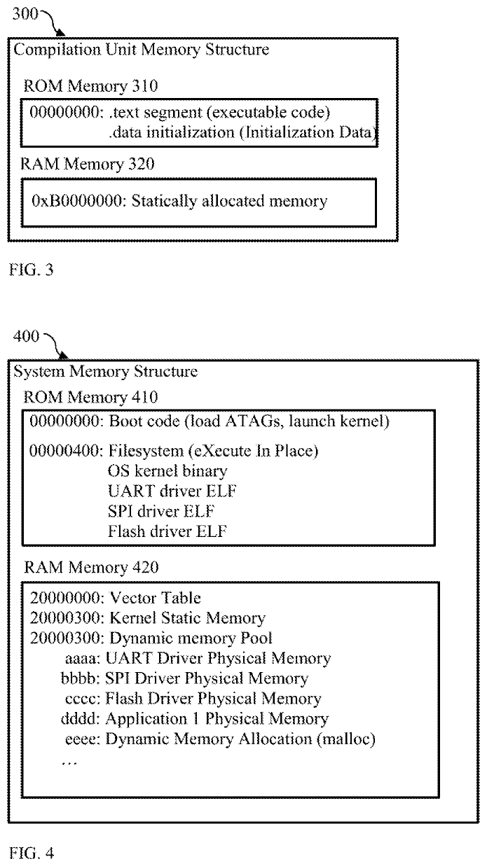

FIG. 3 depicts a memory structure 300 for a compilation unit. The memory structure 300 is determined by a compiler executed on a host computing system, as part of generating the compilation unit for execution on a target computing system (e.g., computing system 200 in FIG. 2). As discussed above, during compilation of one or more software programs, one or more compilation unit(s) may be generated. The memory structure 300 for each compilation unit may comprise a ROM memory 310 (e.g., a region within the memory space of ROM 230) and a virtual RAM memory 320.

In an example embodiment, during compilation of one or more software program(s) on the host computing system, a linker script passed to one or more compilers of the host computing system may include changes to memory allocations, as shown below.

MEMORY
{

FLASH(rx) : ORIGIN = 0x00000000, LENGTH = 4MB
RAM (rwx) : ORIGIN = 0xB0000000, LENGTH = 1MB

}

In the example above, the ROM region is specified as a 4 MB region of flash memory that starts at address zero. In an example embodiment, the size of the ROM region passed to the compiler may be arbitrary, but larger than required for the software program (e.g., storage of the compilation unit generated for the software program) since the specified ROM is effectively an upper bound on an image size. In an example embodiment, a similarly arbitrarily large region may be specified for the RAM region (e.g., a 1 MB RAM region sufficient to store the variables and other data used during execution of the compilation unit). The linker script may cause the compiler of the host computing system to specify the base address to point to a region that is known to be trappable for a target computing system on which the software program will be deployed, in order to provide a hook at runtime to relocate a trappable memory location to a valid physical memory address.

In an example embodiment, the memory structures of different compilation units point to the same ROM 310 and RAM 320 memory segments. That is, at least some of the compilation units may share the same view of memory. For instance, in the example above, each compilation unit may view itself as having been assigned ROM beginning at address 0x00000000 and RAM beginning at address 0xB0000000. The memory view of each compilation unit (more specifically, the compilation unit's view of RAM) would get resolved during run-time execution of the compilation unit, by a virtual memory management subsystem (e.g., VirtualMemory_Handler 231) of a target computing system. A compilation unit may not have any knowledge about the physical memory allocation of its variables. Instead, the virtual memory management subsystem of the target computing system will ensure that the memory accesses requested by the instructions of the compilation unit are to valid physical locations.

In the above embodiment, the compiler can generate ROM code which is completely position independent. The runtime ROM address range may be used as a key to uniquely identify a compilation unit for resolution of a trappable memory access during run-time. In an example embodiment, unlike the traditional approach where the entire system is compiled as a single monolithic image, a memory structure such as that depicted in FIG. 3 may be used to individually compile each compilation unit. In an example embodiment, a kernel, software applications, driver, etc. may have a memory structure similar to that of the compilation unit(s). In an example embodiment, when the compilation unit(s) are executed, a virtual memory management subsystem may perform processing according to the embodiment in FIG. 7 to resolve the memory views of the compilation unit(s) such that the instructions of the compilation unit(s) access valid physical addresses.

FIG. 4 depicts an example memory structure 400 of a computing system (e.g., computing system 200) with a virtual memory management subsystem according to certain embodiments. More specifically, FIG. 4 depicts a system level view of the physical memory in a computing system during runtime execution of one or more compilation unit(s) on the computing system.

In an example embodiment, the system memory structure 400 may comprise two memory structures, a ROM memory 410 and a RAM memory 420, both sharing a unified address space (e.g., a 32-bit address space). More specifically, FIG. 4 depicts a subset or section of addresses that are set aside in ROM memory 410 and RAM memory 420 for each of the devices of the computing system. In the embodiment depicted in FIG. 4, the ROM memory 410 implements a file system for storing executable code including one or more compilation units, while the RAM memory 420 is configured to store data accessed by compilation units during execution of the compilation units. The data stored in RAM memory 420 can include data initialized prior to runtime execution and data generated during runtime execution. ROM memory 410 can be implemented using any suitable type of non-volatile memory and, in certain embodiments, comprises flash memory. FIG. 4 is merely an example. In other embodiments, executable code and program data can be stored in the same memory (e.g., both in RAM).

In an example embodiment, during a startup or boot sequence, the file system of the ROM memory 410 is initialized through execution of bootstrap code stored in ROM memory 410. Initializing the file system may involve executing the bootstrap code using an Execute-in-Place (XIP) method. In an example embodiment, compilation unit(s) can also be executed-in-place during run-time, e.g., directly from ROM memory 410.

In an example embodiment, the bootstrap code may load an ATAGs string containing runtime parameters. For example, the ATAGs string “RAM=0x20000000 RSZ=16 k IRQ=0” may be decoded to allocate 16 kB of RAM located beginning at address 0x20000000 of the RAM memory 420 and without user Interrupt Requests (IRQs).

The ATAGs string above is merely an example. In another embodiment, while running the bootstrap code, the operating system 230 may load a different ATAGs string that contains relevant memory and system information. For example, the string “RAM=0x20000000 RSZ=256 k IRQ=21” informs the operating system or the kernel within the operating system that there is 256 kB of RAM available at address 0x20000000. The kernel or operating system 230 may then unpack itself into the available memory. Prior to the kernel starting, the operating system 230 may relocate its vector table to RAM 420, which gives the operating system access to trap any accesses to the invalid or trappable memory region. In an example embodiment, the bootstrap code in ROM 410 may include ARM thumb2 assembly startup code that forms part of the kernel.

As depicted in FIG. 4, in certain embodiments, the file system of ROM memory 410 can include Executable and Linkable Format (ELF) files. ELF is a standard file format used for executable files, object code, shared libraries, and core dumps. In an example embodiment, each ELF file may be a compilation unit, where the compilation unit may be at least one of a driver, an application, a shared library, etc. For example, as depicted in FIG. 4, ELF files may be provided for a UART (Universal Asynchronous Receiver/Transmitter) driver, an SPI (Serial Peripheral Interface) driver, a flash driver, etc.

The ELF files may be loaded during file system initialization and for execution within a memory space of ROM 410. The combination of a file system that supports XIP and an ELF loader is optional, but would enable the operating system to load and execute one or more compilation units in an efficient manner.

As depicted in FIG. 4, in certain embodiments, the file system of ROM memory 410 may include an operating system (OS) kernel binary comprising kernel code that controls the computing system having memory structure 400. In certain embodiments, the source code for a virtual memory management subsystem may be assembly code compiled as part of the OS kernel.

As indicated above, RAM memory 420 may be configured to store data used during program execution (e.g., execution of the operating system and execution of one or more compilation units corresponding to drivers or other software programs). In certain embodiments, RAM memory 420 may include both static and dynamic memory. Static memory is allocated at compile time (e.g., by a compiler of a host system) and dynamic memory is allocated at runtime (e.g., by an operating system of a target computing system). As depicted in FIG. 4, a dynamic memory pool in RAM 420 may comprise segments of physical memory allocated to one or more compilation units.

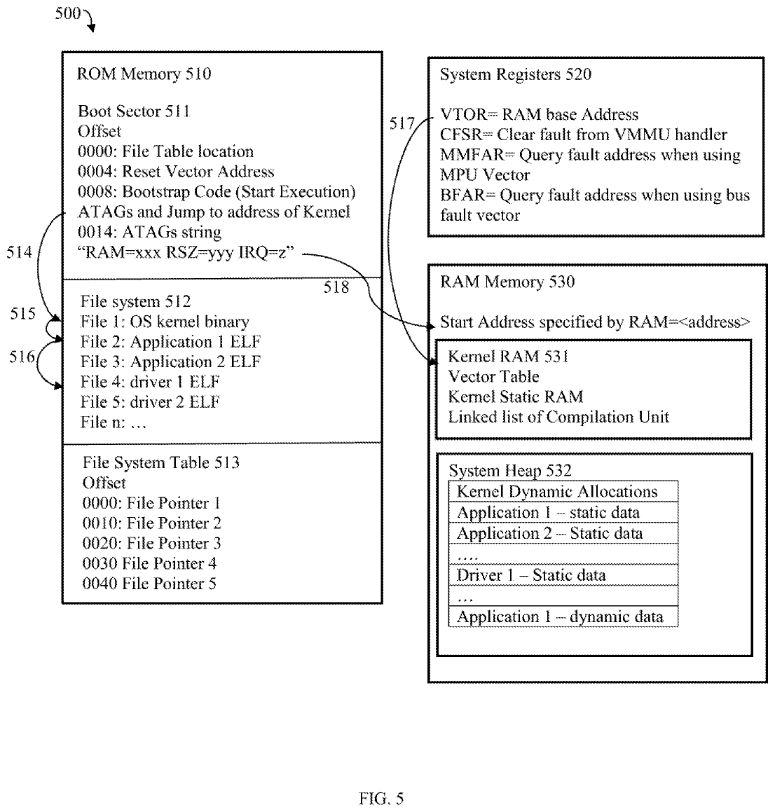

FIG. 5 depicts an example memory structure 500 of a computing system (e.g., computing system 200). FIG. 5 depicts the memory structure 500 in greater detail compared to the embodiment of FIG. 4 and includes process calls. Similar to the memory structure 400 in FIG. 4, the memory structure 500 includes a ROM memory 510 and RAM memory 530. FIG. 5 also shows various system registers 520 within the computing system.

As depicted in FIG. 5, in certain embodiments, during execution of one or more software program(s) on the computing system, bootstrap code contained in a boot sector 511 of the ROM memory 510 loads an ATAGs string (step 514). As discussed above in connection with FIG. 4, an ATAGs string may contain runtime parameters. For example, the ATAGs string loaded in step 514 could be “RAM=0x20000000 RSZ=256 k IRQ=21,” as discussed above. The ATAGs string loaded in step 514 may specify an arbitrary start address (0x20000000) that corresponds to a beginning of a trappable memory region and that requires patching during execution (in step 517, discussed below).

During initialization of the computing system, the operating system (e.g., the operating system comprising VirtualMEM_Handler 231 in FIG. 2) loads one or more compilation units (step 515). For example, step 515 may involve loading ELF files that are located in the file system 512, using a built-in ELF loader. During the loading in step 515, one or more ELF files associated with applications may request loading of one or more drivers, which are in turn loaded in step 516.

In certain embodiments, during initialization, the operating system or kernel sets up a stack pointer at the top of available RAM (step 517). The section of RAM 530 to which the stack pointer points is for storing data associated with the kernel, and is referred to herein as a kernel RAM 531. Additionally, the kernel may back up a callee saved register if the kernel was called from a context other than reset (indicated, for example, when a link register has a value other than 0xFFFFFFFF) to allow nested calls between one kernel and another kernel.

During initialization, once the kernel receives and decodes the ATAGs string (step 518), the kernel knows where RAM 530 is located. In certain embodiments, the kernel will, upon receiving and decoding the ATAGs string, start unpacking its own variables into RAM 530, more specifically, into kernel RAM 531. Afterwards, the kernel may relocate a vector table to kernel RAM 531 and generate a system heap 532. The vector table is an Interrupt Service Routine (ISR) vector table that identifies interrupt handlers for handling various types of interrupts, including interrupts caused by an attempt to access invalid/trappable memory. After the vector table has been relocated, its location may be updated in a Vector Table Offset Register (VTOR) that is part of the system registers 520.

In certain embodiments, during initialization, the operating system whose vector table has been relocated to kernel RAM 531 may configure a Memory Protection Unit (MPU) or bus fault interrupt to trap future memory faults. One of these fault trapping mechanisms may be used alone, or both used in combination, for purposes of trapping faults caused by accesses to trappable memory. When bus fault interrupts are used, a fault address can be read from a bus fault address register (BFAR). When an MPU is used, the fault address can be read from a fault address register controlled by the MPU, e.g., a MemManage Fault Address Register (MMFAR).

As depicted in FIG. 5, kernel RAM 531 may store a linked list of compilation units. This linked list may identify each compilation unit located in the file system 512 of ROM memory 510. The exact location of each file/compilation unit in the file system 512 may be stored as part of a data structure maintained by the operating system, for example, as file pointers in a file system table 513. The file system table 513 may be located after the file system 512, e.g., at some offset of the last address associated with the file system 512.

In an example embodiment, the kernel may allocate memory in the system heap 532 for use during execution of compilation units. The system heap 532 can include static data loaded by the ELF loader at runtime and dynamic data generated during runtime execution of compilation units. After the contents of the kernel RAM 531 and system heap 532 have been initialized and at least one fault trapping mechanism (e.g., bus fault or MPU based) has been configured, the kernel can be executed by calling its main function.

Once the kernel begins executing, one or more compilation units (e.g., ELF files) associated with software applications can be executed through the kernel. During execution of a compilation unit, an instruction of the compilation unit may try to access trappable or invalid memory. The following source code example includes instructions in the C programming language and illustrates a data access that may trigger a fault that can be handled using the virtual memory management techniques described herein.

unsigned int A;
int main (int argc, char **argv)
{

A=42;
return A;

}

In a sample compilation of the above source code, the compiler may choose to store the address of variable A in the first four bytes of memory, and may produce the following assembly code for a compilation unit. The assembly code below illustrates how the compilation unit attempts to fetch data from the trappable memory region at address 0xB0000000. In particular, the address of variable A is loaded based on the contents of a base register r3 that points to address 0xB0000000. When register r3 is dereferenced, this triggers a fault (e.g., a bus fault or fault associated with an MPU).

| // Backup frame pointer, make room in stack | |
|---|---|
| \| 0xb8 <main> | push {r7} |
| \| 0xba <main+2> | sub sp, #12 |
| // Set up new frame pointer, backup r0,r1 | |
| \| 0xbc <main+4> | add r7, sp, #0 |
| \| 0xbe <main+6> | str r0, [r7, #4] |
| \| 0xc0 <main+8> | str r1, [r7, #0] |
| // Load address of variable A pointer (0xafffff38 + $pc = 0x0000000) | |
| \| 0xc2 <main+10> | ldr r3, [pc, #28] ; (0xe0 <main+40>) |
| \| 0xc4 <main+12> | add r3, pc |
| // Load offset of variable A pointer (=0) | |
| \| 0xc6 <main+14> | ldr r2, [pc, #28] ; (0xe4 <main+44>) |

// Read actual address of variable A
// Dereferencing r3=0xB0000000 will cause a fault. This fault will trigger execution

of the VirtualMem_Handler( ) which will resolve the physical address and patch r3. Upon returning
from the fault, this instruction will be re-executed and the address of variable A will be stored in
r2.

| \| 0xc8 <main+16> | ldr r2, [r3, r2] |
|---|---|
| // Shuffle registers, move constant 42 into r2 | |
| \| 0xca <main+18> | mov r1, r2 |
| \| 0xcc <main+20> | movs r2, #42 ; 0x2a |
| // Store r2 into variable A address calculated above | |
| \| 0xce <main+22> | str r2, [r1, #0] |
| // Reload variable A offset (=0) | |
| \| 0xd0 <main+24> | ldr r2, [pc, #16] ; (0xe4 <main+44>) |
| // Load the address of A | |
| \| 0xd2 <main+26> | ldr r3, [r3, r2] |
| // Get the value of A | |
| \| 0xd4 <main+28> | ldr r3, [r3, #0] |
| // Copy value of A to return register | |
| \| 0xd6 <main+30> | mov r0, r3 |
| // Restore stack pointer | |
| \| 0xd8 <main+32> | adds r7, #12 |
| \| 0xda <main+34> | mov sp, r7 |
| \| 0xdc <main+36> | pop {r7} |
| // Return to caller | |
| \| 0xde <main+38> | bx 1r |
| // Compiler generated constants | |
| \| 0xe0 <main+40> | .word 0xafffff38 |
| \| 0xe4 <main+44> | .word 0x00000000 |

In certain embodiments, when a base register is dereferenced during execution of an instruction that performs a data access, a bus fault is triggered due to the memory address not being available when a bus transaction is issued. The bus fault may result in a call to a fault handler of the virtual memory management subsystem (e.g., VirtualMem_Handler 231 in the embodiment of FIG. 2). The fault handler may be accessed via a vector table, e.g., the vector table that was relocated into kernel RAM 531.

In certain embodiments, the fault handler of the virtual memory management subsystem may perform the following steps to resolve the bus fault. 1) Read the stored program counter to obtain the execution address of the faulting instruction. 2) Read a data structure of one or more loaded compilation unit(s) to identify the locations of each compilation unit. 3) Compare the program counter to the range of execution addresses of each compilation unit to find a match. 4) If no match is found then the fault handler treats the fault as valid bus fault, as further explained below in connection with step 750 of FIG. 7.

5) If a match is found then identify the fault address of the instruction (i.e., the address that the instruction tried to access) from a Bus Fault Address Register (BFAR). 6) Subtract the virtual base address (e.g., 0xB0000000) and the execution address from the fault address. 7) Add the physical base address of the matching compilation unit (e.g., the starting address of the portion of system heap 532 assigned to the compilation unit). 8) Decode the instruction responsible for triggering the fault and patch the register responsible for triggering the fault (e.g., r3 or some other register that was referenced by the instruction for determining which address to access). 9) Return from the fault by branching to a link register (LR). The branching allows the instruction to be re-executed successfully.

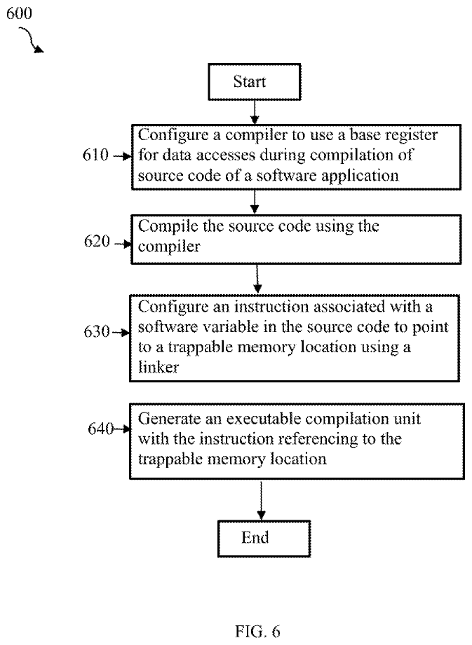

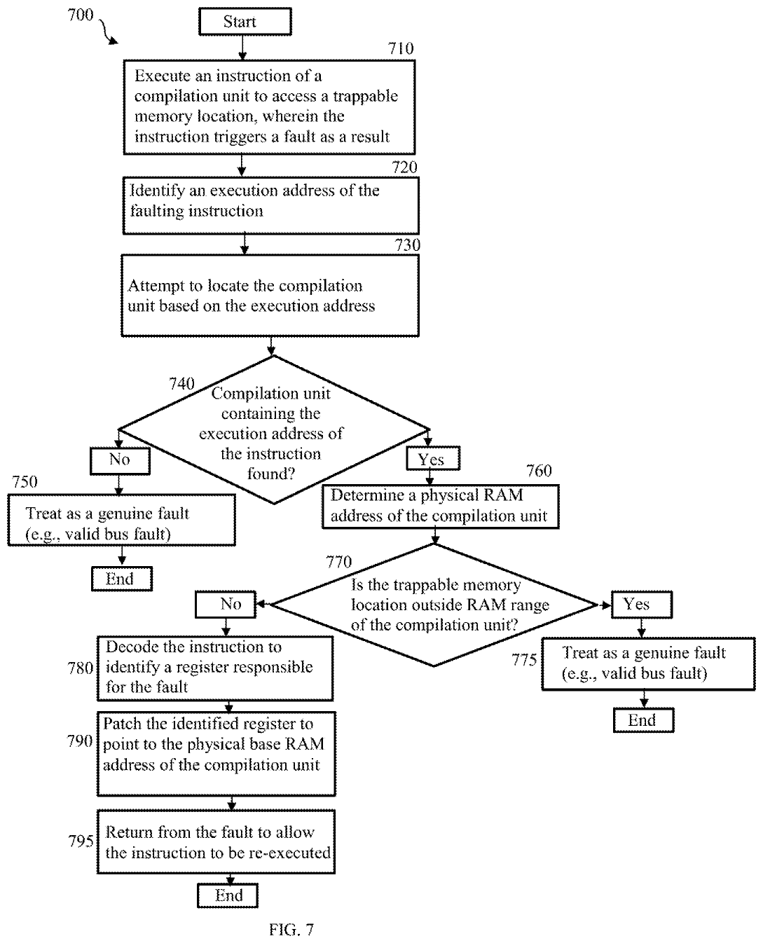

FIG. 6 depicts steps performed during a compilation of a software program. The steps depicted in FIG. 6 include steps that can be performed by a host computing system separate from the computing system (e.g., computing system 200) on which the compilation unit resulting from the compilation of the software program is executed. A developer generates/writes source code (including a kernel/OS and at least one software application application) for deployment on a target computing system. Included with the source code is a memory map pointing to a virtual base address known to be an trappable address that is unused by the system (e.g., 0xB0000000 in the embodiment depicted in FIG. 3).

In step 610, the virtual memory management subsystem of the target computing system or the operating system of the host computing system may direct the compiler/linker of the host computing system to configure all data accesses to reference a particular register as a base offset register during compilation of source code of the software application. For instance, in certain embodiments, the operating system of the host computing system may specify to the compiler/linker that all data accesses (e.g., accesses to RAM) should be performed via a fixed PIC (position independent code) base register used for PIC addressing. For a standard PIC base case, the base offset register may be any suitable register determined by the compiler. In the ARM architecture and for a fixed PIC base case, the default register may be register R9 if the target computing system is Embedded Application Binary Interface (EABI) based or if stack-checking is enabled, otherwise the default register may be R10. Using a fixed PIC base register may improve overall performance during the virtual memory resolution process.

In an example embodiment, a GCC compiler may set a flag -mpic- register=r9 during compilation of one or more software programs. The setting of this flag tells the compiler to use R9 as the base register for the compilation unit's static memory references. In an example embodiment, during execution of the compilation unit, the base register initially stores a value pointing to a trappable memory address. The initial value of the base register can be based on the starting RAM address in the compilation unit's memory structure (e.g., 0xB0000000) and will get replaced with a valid physical base address to resolve a fault (associated with a request to access trappable memory) triggered by an instruction of the compilation unit.

In an example embodiment, during the execution of the compilation unit, the first data access may result in a faulting and patching sequence (as described below in connection with FIG. 7) that resolves the physical address. In an example embodiment, any further accesses from the same compilation unit may then be referenced from the base register (that now points to a valid RAM base address), and therefore will not produce the same fault.

In step 620, the source code along with one or more compilation flags are compiled using the compiler. In step 630, the virtual memory management subsystem may pass a linker script to the linker during compilation of one or more software programs, where the linker script specifies the ROM and RAM address spaces to use. The RAM address space is configured to exist in trappable memory. This effectively provides a hook at runtime to relocate the accessed memory to a valid physical address based on runtime parameters.

In step 640, the compiler generates an executable compilation unit with at least one instruction referencing the trappable memory location (e.g., an instruction that accesses the trappable memory location via a value stored in a PIC base register). In certain embodiments, the processing in steps 620-640 may be repeated to generate a plurality of compilation units, including a compilation unit for a kernel and a compilation unit for a software application, for deployment on a target computing system.

FIG. 7 depicts steps performed during execution of a software program by a target computing system (e.g., computing system 200) including a virtual memory management subsystem (e.g., VirtualMemory_Handler 231). During loading of one or more executable files (e.g., compilation units) containing compiled instructions of the software program, the operating system allocates memory for each compilation unit during runtime based on resources available.

In step 710, an instruction of a compilation unit is executed and triggers a fault, and therefore an interrupt, as a result of a request to access a trappable or invalid memory location. An operating system of the target computing system traps memory requests destined for the trappable memory region containing the memory location requested by the instruction. In some embodiments, the compilation unit may be an executable file (e.g., an ELF file) containing a set of compiled instructions of a software program. In an example embodiment, the operating system may, in step 710, execute or invoke the VirtualMemory_Handler 231 as the fault/interrupt handler to be used for handling the interrupt caused by the request to access the trappable memory location.

In step 720, the virtual memory management subsystem, which can be part of the operating system that trapped the memory request in step 710, identifies an execution address of the faulting instruction. The virtual memory management subsystem may identify the execution address using a program counter (PC) of a CPU executing the instruction (e.g., CPU 220).

In step 730, the virtual memory management subsystem may attempt to locate the compilation unit based on the execution address of the instruction responsible for triggering the fault.

In step 740, as part of attempting to locate the compilation unit, the virtual memory management subsystem may determine whether any compilation unit contains the execution address identified in step 720, e.g., whether the identified execution address is within a range of the ROM memory assigned to any compilation unit. The ROM memory range can, for example, be a range of assigned addresses in the ROM memory 410 of FIG. 4 or the ROM memory 510 of FIG. 5. In this manner, the virtual memory management subsystem can determine whether the instruction that triggered the fault in step 710 is an instruction that is stored (e.g., in the file system 512 of FIG. 5) as part of any compilation unit that has been loaded onto the target computing system and, more specifically, stored as part of the compilation unit that is currently being executed. If no compilation unit contains the identified execution address, then the process proceeds to step 750. Otherwise, the compilation unit will have been successfully located, and the process proceeds to step 760.

In step 750, the fault is deemed a “genuine” fault (e.g., a valid bus fault or some other fault that does not require handling by the virtual memory management subsystem). The operating system may handle the fault using an appropriate fault handler. For instance, the operating system may execute a handler indicated by an ISR vector table.

In step 760, the virtual memory management subsystem may determine a physical memory address (e.g., a RAM address) of the compilation unit that has now been located. The physical memory address can be a RAM address assigned to the compilation unit by the operating system (e.g., in the embodiment of FIG. 4, a starting address of a region in RAM 420 allocated to the compilation unit for storing data). The virtual memory management subsystem may query data structures maintained by the operating system to determine RAM location and size associated with the compilation unit.

In step 770, the virtual memory management subsystem may determine whether the trappable memory location is outside the physical memory (RAM) range of the compilation unit. More specifically, the virtual memory management subsystem may determine whether a faulted memory region is within the bounds of the physical memory range allocated to the compilation unit by the operating system. As part of the processing in step 770, the virtual memory management subsystem may identify the faulted memory region by reading a fault address from a bus fault register or other register storing an address corresponding to the trappable memory location.

The virtual memory management subsystem may then compare the fault address to the physical memory range allocated to the compilation unit. If the trappable memory location is outside the RAM range of the compilation unit, then the fault is deemed a genuine fault (e.g., a valid bus fault) and the process proceeds to step 775, where the fault is handled using an appropriate fault handler. Otherwise, the virtual memory management system will recognize the fault as being a fault that can be handled through patching and the process proceeds to step 780.

In step 775, the operating system handles the fault using an appropriate fault handler. The processing in step 775 can be performed in the same manner as in step 750, using a fault handler indicated by the ISR vector table.

In step 780, the virtual memory management subsystem decodes the instruction to identify a register responsible for the fault (e.g., a base register referenced by the instruction to compute the address of the trappable memory location that was requested in step 710).

In step 790, the virtual memory management subsystem patches the register associated with the instruction, i.e., the register identified in step 780. In certain embodiments, to patch the register associated with the instruction responsible for triggering the fault, the virtual memory management subsystem may update the register to point to the physical memory address determined in step 760 (e.g., a base RAM address of the compilation unit). Depending on the addressing scheme used by the target computing system, the address with which the register is updated may, in certain embodiments, be an address computed based on the physical memory address determined in step 760 rather than the exact physical memory address determined in step 760. For instance, the register may be patched using an address that is an offset of the physical memory address determined in step 760. Thus, the address used to patch the register associated with the instruction responsible for triggering the fault may be a physical memory address computed by the virtual memory management subsystem or a physical memory address obtained through a look up of a data structure maintained by the operating system.

In certain embodiments, the virtual memory management subsystem computes the address used for patching based on the execution address identified in step 720 and a fault address corresponding to the trappable memory location that the instruction attempted to access. If the fault triggered in step 710 is a bus fault, then the fault address can be an address obtained from a bus fault address register. For example, the fault address can be read from the bus fault address register in conjunction with identifying the execution address in step 720, after the determination in step 740, or after the determination in step 770. As discussed above, one way to compute the address used for patching is to subtract a virtual base address (the starting address of a memory region containing the trappable memory location) and the execution address from the fault address, then add the result to the physical base address of the compilation unit (e.g., to the physical memory address determined in step 760). In some implementations, additional calculations may be performed to compute the address used for patching depending on whether the trappable memory location was determined as an offset of the virtual base address. Again, the manner in which the address for patching is determined is dependent on the addressing scheme of the target computing system and may vary from one computing system to another.

In step 795, once the register associated with the instruction is patched, the virtual memory management subsystem returns from the fault. In certain embodiments, the operating system may, upon return from the fault, re-execute the instruction so that the instruction can execute successfully through access to a valid physical memory location. Additionally, as indicated earlier, subsequent instructions of the compilation unit that perform data accesses will execute successfully and without triggering a fault, by virtue of referencing the same register which was patched in step 790.

The processing depicted in FIG. 7 can be repeated each time a new compilation unit is executed (e.g., when switching between different compilation units) so that a physical memory address for patching the register can be determined on a per compilation unit basis.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method for memory management in a computing system, the method comprising:
executing, by an operating system, an instruction of a compilation unit, wherein the instruction triggers a fault as a result of an attempt by the instruction to access a trappable memory location, and wherein the instruction was configured, by a software compiler, to reference the trappable memory location;
handling, by the operating system, the fault, wherein handling the fault comprises:
determining, by the operating system, an address of a physical memory location to use in place of the trappable memory location; and
patching, by the operating system, a register pointing to the trappable memory location to instead point to the physical memory location; and
returning, by the operating system, from the fault, wherein upon the returning from the fault, the instruction is re-executed.

2. The method of claim 1, wherein determining the address of the physical memory location comprises:
identifying, by the operating system, an execution address of the instruction;
identifying, by the operating system, a fault address corresponding to the trappable memory location that the instruction attempted to access; and
calculating, by the operating system, an address of the physical memory location using the execution address and the fault address.

3. The method of claim 2, wherein the step of identifying the fault address comprises obtaining, by the operating system, the fault address from a hardware based fault register.

4. The method of claim 1, further comprising:
determining a physical base address assigned to the compilation unit, wherein determining the physical base address comprises querying, by the operating system, one or more data structures maintained by the operating system to determine a Random Access Memory (RAM) location associated with the compilation unit.

5. The method of claim 1, further comprising:
as a condition for handling the fault, verifying that the instruction that triggered the fault is stored as part of the compilation unit and that the trappable memory location is within a physical memory range allocated to the compilation unit.

6. The method of claim 1, wherein the compilation unit comprises a set of compiled instructions including the instruction that triggered the fault.

7. The method of claim 1, further comprising:
configuring, by the operating system and prior to executing the compilation unit, an Interrupt Service Routine (ISR) vector table to trap accesses to a memory region containing the trappable memory location.

8. The method of claim 1, wherein patching the register pointing to the trappable memory location comprises replacing the address of the trappable memory location, as stored in the register, with the address of the physical memory location.

9. The method of claim 1, wherein the instruction attempts to access the trappable memory location as a result of being configured by the software compiler to access Random Access Memory (RAM) data indirectly through referencing the register, and wherein the register is a base register.

10. The method of claim 9, wherein the register is a Position Independent Code (PIC) base register.

11. A system for memory management, comprising:
a physical memory;
one or more processors; and
an operating system residing in the physical memory and executable by the one or more processors, wherein the operating system is configured to:
execute an instruction of a compilation unit, wherein the instruction triggers a fault as a result of an attempt by the instruction to access a trappable memory location, and wherein the instruction was configured, by a software compiler, to reference the trappable memory location;
handle the fault, wherein to handle the fault, the operating system is configured to:
determine an address of a physical memory location to use in place of the trappable memory location; and
patch a register pointing to the trappable memory location to instead point to the physical memory location; and
return from the fault, wherein upon returning from the fault, the instruction is re-executed.

12. The system of claim 11, wherein to determine the address of the physical memory location, the operating system is configured to:
identify an execution address of the instruction;
identify a fault address corresponding to the trappable memory location that the instruction attempted to access; and
calculate an address of the physical memory location using the execution address and the fault address.

13. The system of claim 12, wherein to identify the fault address, the operating system is configured obtain the fault address from a hardware based fault register.

14. The system of claim 11, wherein the operating system is further configured to:
determine a physical base address assigned to the compilation unit, wherein to determine the physical base address, the operating system queries one or more data structures maintained by the operating system to determine a Random Access Memory (RAM) location associated with the compilation unit.

15. The system of claim 11, wherein the operating system is further configured to:
as a condition for handling the fault, verify that the instruction that triggered the fault is stored as part of the compilation unit and that the trappable memory location is within a physical memory range allocated to the compilation unit.

16. The system of claim 11, wherein the compilation unit comprises a set of compiled instructions including the instruction that triggered the fault.

17. The system of claim 11, wherein the operating system is further configured to:
configure, prior to executing the compilation unit, an Interrupt Service Routine (ISR) vector table to trap accesses to a memory region containing the trappable memory location.

18. The system of claim 11, wherein to patch the register, the operating system is further configured to replace the address of the trappable memory location, as stored in the register, with the address of the physical memory location.

19. The system of claim 11, wherein the instruction attempts to access the trappable memory location as a result of being configured by the software compiler to access Random Access Memory (RAM) data indirectly through referencing the register, and wherein the register is a Position Independent Code (PIC) base register.

20. A non-transitory computer-readable memory storing a plurality of instructions that, when executed by one or more processors of a computing system, cause the one or more processors to perform processing comprising:
executing an instruction of a compilation unit, wherein the instruction triggers a fault as a result of an attempt by the instruction to access a trappable memory location, and wherein the instruction was configured, by a software compiler, to reference the trappable memory location;
handling the fault, wherein handling the fault comprises:
determining an address of a physical memory location to use in place of the trappable memory location; and
patching a register pointing to the trappable memory location to instead point to the physical memory location; and
returning from the fault, wherein upon returning from the fault, the instruction is re-executed.
